(19) United States
(12) Patent Application Publication
(10) Pub. No.: US 2010/0251906 A1
(43) Pub. Date: Oct. 7, 2010

(54) SALAD SPINNER

(76) Inventors: Timothy Corcoran Repp, Pleasant Valley, CT (US); Thomas B. Murphy, Arlington, TX (US)

Correspondence Address: Daniel V. Thompson;The Law Offices Of Daniel V. Thompson P.C., 9304 Forest Lane,, Suite N253, Dallas, TX, 75243, US

(21) Appl. No.: 12/753,300

(22) Filed: Apr. 2, 2010

Related U.S. Application Data
(60) Provisional application No. 61/211,653, filed on Apr. 2, 2009.

(51) Int. Cl. A47J 43/00

(52) U.S. Cl. 99/495

(57) ABSTRACT

A rotatable greens drying device that includes a lid, a rotatable colander, a drive mechanism for rotating the colander, and a receiving ring fan which transfers rotational force from the drive mechanism to the rotatable colander. The fast moving, drier air circulated by the receiving ring fan naturally helps evaporate moisture from the surface of the greens and it helps expel water through container holes. This embodiment also allows air exposure of the leafy contents via the perforations within the spinning colander which further reduces surface moisture.

### CROSS-REFERENCE TO RELATED APPLICATION

This is a non-provisional application based on U.S. Provisional Patent Application Ser. No. 61/211,653 filed on Apr. 2, 2009.

### TECHNICAL FIELD

The present invention relates to an improved food preparation product. More particularly, it is a rotatable greens drying device (hereinafter, salad spinner) that decreases the time and effort required to dry washed greens by more effectively removing surface moisture by means of an integral air circulation mechanism and rotational forces.

### BACKGROUND OF THE INVENTION

Salad spinner devices are common and not new to the marketplace. All known salad spinners are designed to create centrifugal force that expedites removal of residual water which accumulates after rinsing leafy vegetables. This is done to avoid soggy greens which can detract from the texture and quality of a salad. Each known device in the prior art employs a mechanical method for swiftly rotating a perforated container filled with rinsed greens inside a vessel that captures and contains water after its removal. This mechanical method is not the subject of this disclosure as it could be satisfactorily achieved by using one of several drive mechanisms already known in the public domain.

Most salad spinner devices consist of five main components: a rigid and stationary exterior main bowl with a lid, an interior rotatable colander with an engageable lid, and a rotary drive device that is fastened to the exterior lid which when activated by the user, spins the interior lid and colander in unison. The user typically will fill the colander with leafy greens and wash them thoroughly under a faucet. Then, the dripping colander is placed inside the main bowl on a countertop, the lid assembly (containing the exterior lid, interior lid and the rotary device) is placed on top of the bowl and the user activates the rotary drive device to create the centrifugal force needed to remove water from the greens. Unfortunately, because of the nature of the centrifugal force, the contents are thrust outward against the perforated inner walls of the colander, obstructing the very holes meant to allow water to escape. Many times the user must stop and ‘fluff up’ the contents and spin again for adequate results.

There is a need, then, for a salad spinner device that, in conjunction with centrifugal force, includes features that accelerate drying time while making less work for the user.

SUMMARY OF THE INVENTION

The salad spinner of the present invention includes a support frame that suspends a removable colander over a sink or basin. The support frame also provides a removable drive assembly to communicate with the colander as well as serving as a cutting surface. An engagement device integral to the removable drive assembly further communicates with a receiving ring affixed to the top of the colander. When the removable drive assembly is actuated, it rotates the receiving ring which in turn rotates the colander creating the desired centrifugal force. Integral to the engagement device are a plurality of radial vanes which are shaped to draw air in and direct it down and through the colander as its rotation speed increases.

### BRIEF DESCRIPTION OF THE DRAWINGS

A more complete understanding of the invention and its advantages will be apparent from a review of the Detailed Description in conjunction with the following Drawings, in which:

FIG. 1 is a perspective view of a salad spinner constructed in accordance with the invention, with perforations in the colander omitted for clarity.

FIG. 2 is an exploded perspective view of the salad spinner of FIG. 1 showing the removable drive assembly, the receiving ring fan, colander, and support frame.

FIG. 3 is a perspective view of the Salad Spinner of FIG. 1 in the use configuration with removable drive assembly removed.

FIG. 4 is a perspective view of the Salad Spinner of FIG. 1 in the use configuration with the removable drive mechanism and receiving fan removed.

FIG. 5 is perspective view of an alternative stand-alone embodiment of the salad spinner with a rigid outer basket in the use configuration.

FIG. 6 is a cutaway perspective view of the salad spinner of FIG. 5.

### DETAILED DESCRIPTION

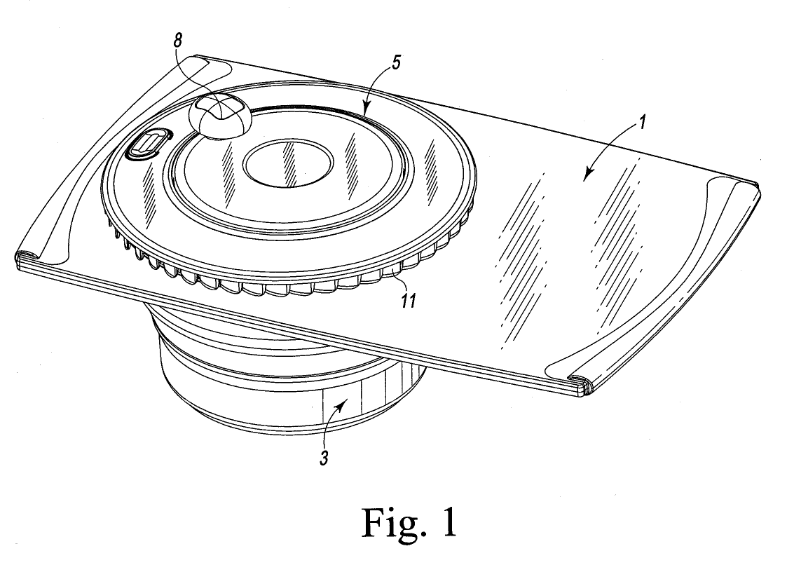

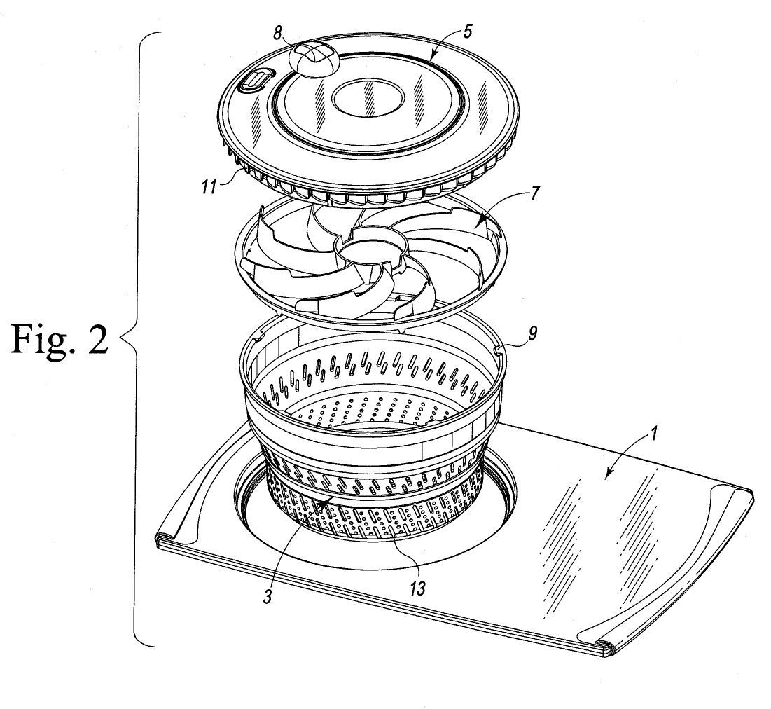

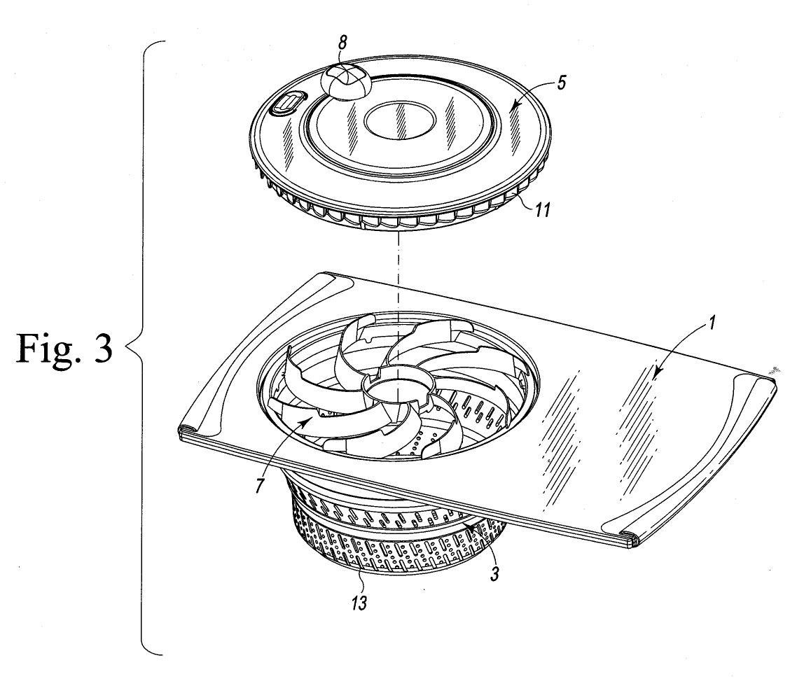

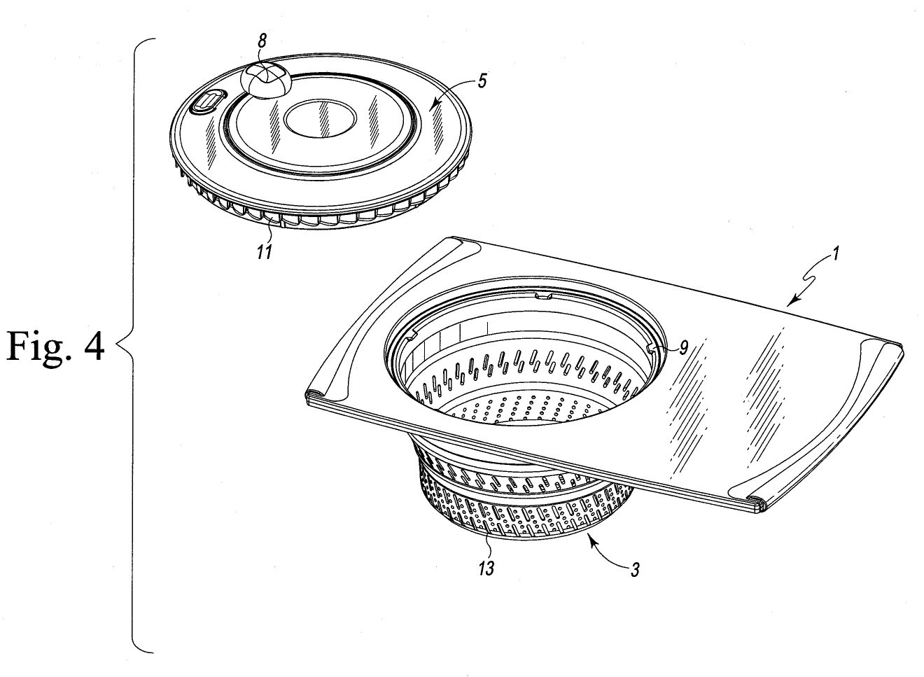

Referring initially to FIGS. 1-4, where like numerals indicate like and corresponding elements, the user places the support frame 1 over the top perimeter of a sink or basin. The collapsible, flexible colander 3 rests on a receiving aperture 4 within the support frame 1. Leafy greens are placed inside the colander 3, washed with water and spread evenly. The removable drive assembly 5, with attached receiving ring fan 7 and actuator 8, is removably coupled to the support frame and colander by placing it on top of the support frame 1 directly above the colander 3. The removable drive assembly 5 self-locates with the receiving ring fan 7 affixed to the colander rim 9 so as to transfer driving input from actuator 8 and the mechanical output of the removable drive assembly 5 to the receiving ring fan 7 and attached colander 3. The removable drive assembly 5 is actuated, gradually rotating the colander 3 about an axis of rotation (not shown) to initiate centrifugal force which begins removal of water from the leafy greens. As speed increases, radial vanes 11 within the removable drive assembly 5 force dry air through the leafy greens and the colander holes 13. The user then lifts the removable drive assembly 5 from the top of the support frame 1 and either removes the leafy greens by hand, or alternatively lifts out the colander 3 from the support frame 1 and pours the leafy greens into a separate bowl for consumption.

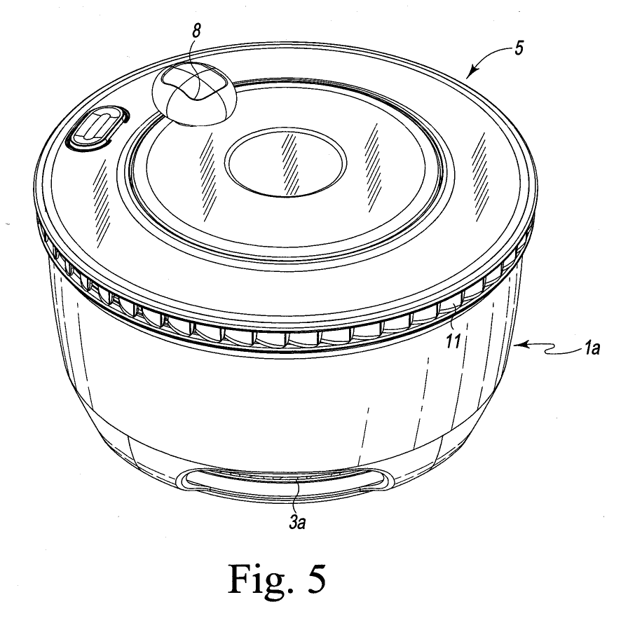

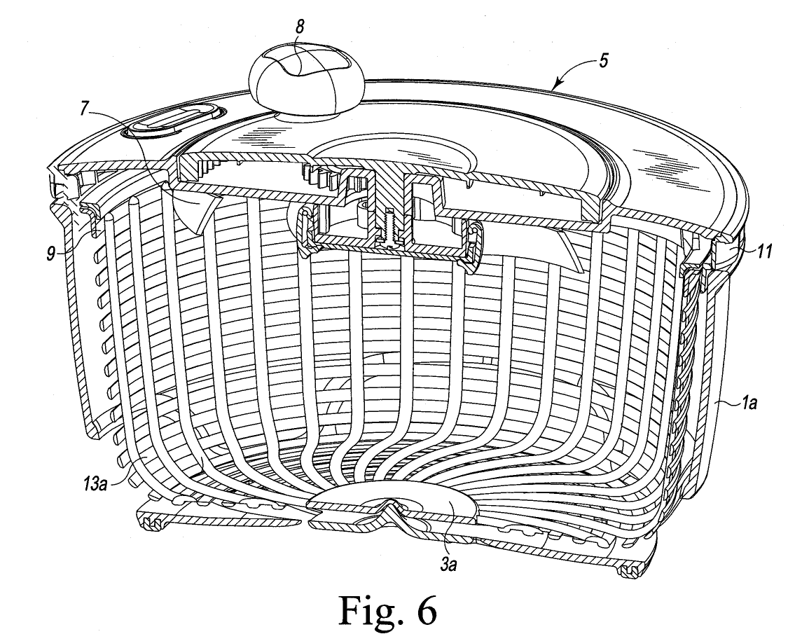

Referring now to FIGS. 5 and 6, an alternative embodiment features a stand-alone support frame 1a configured to be supported by the bottom surface of a sink or basin, rather than the top perimeter of the sink or basin as with the previously described embodiment. Colander 3a, with colander holes 13a, is a traditional rigid colander as opposed to the collapsible, flexible colander 3. The remaining elements, including removable drive assembly 5, receiving ring fan 7, and actuator 8, are substantially the same as previously described.

In operation, the salad spinner of this invention includes features that accelerate drying time while making less work for the user, including elements that create and promote dry airflow throughout the contents of the salad spinner device. First, the traditional interior engageable lid is changed to an engagement device containing a series of vanes shaped to draw in and direct dry air onto and throughout the greens during the spinning process. The fast moving, drier air helps evaporate moisture from the surface of the greens and helps expel water through the container holes. Second, the leafy contents are exposed to air via the perforations within the spinning colander, which further reduces surface moisture. This is beneficial since a traditional exterior bowl can throw splashing water droplets back onto the surface of the greens defeating the drying process.

Next, in the first embodiment described this invention includes a novel arrangement that can be suspended over a sink. This not only eliminates the need for a rigid exterior bowl to catch and contain water, but it saves having to manually empty water from the bowl after use. Another feature is that the colander can be made collapsible, such that the colander can substantially reduce its size so the entire device can be assembled and stored in a limited space. Still another feature is the optional cutting surface for preparing food. Finally, the device can alternatively utilize a traditional secondary rigid exterior bowl to catch and contain water.

Though it is intended to fully describe the invention as set forth here, it is reasonable to assume that one skilled in the art could adjust, modify, subtract or adapt certain aspects of this salad spinner device without departing from its original scope. The implementation of individual or combined improvements disclosed here as part of another salad spinner device would be obvious. For example, adding any type of air-moving vanes to a new salad spinner device would be well within the bounds of what has been revealed herein. Another example would be to omit the rigidity of the colander and employ a collapsible version. Still another example would be to support or suspend this salad spinner device by another method such as with folding legs or a rigid outer bowl. The colander itself could, in fact, be freestanding—its lower end engaging with an electronic or manual drive component placed on the floor of a sink.

Various known drive mechanism could include pull-chord escapements, levers, gear sets, plungers, and electric motors. Again, these mechanisms are not the subject matter of this disclosure. The gist of this improved salad spinner is that in addition to centrifugal force, its driven components create and utilize moving air to dry greens in less time with less effort. It can also function above or within a sink which keeps splashing water off countertops and eliminates the need for an exterior bowl. Lastly, its size can be reduced for storage in limited spaces.

The recommended materials will likely be, but are not limited to rigid and elastomeric plastic or metal.

While the invention has been illustrated and described as embodied in two alternative salad spinners, it is not intended to be limited to the details shown, since it will be understood that various omissions, modifications, substitutions and changes in the forms and details of the device illustrated in its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is:

1. A salad spinner comprising:
a support frame;
a colander supported by the support frame for rotation about an axis of rotation; and
a removable drive assembly removably coupled to the support frame and colander,
wherein the removable drive assembly comprises an actuator to transmit a driving input applied to the actuator to rotate the colander, and with an air circulation device mechanically coupled to the actuator to circulate air inside the colander.

2. The salad spinner of claim 1, wherein the actuator is a manually operated rotating handle.

3. The salad spinner of claim 1, wherein the air circulation device is a fan.

4. The salad spinner of claim 3, wherein the fan is mechanically coupled to the colander to transmit a driving input directly from the actuator.

5. The salad spinner of claim 1, wherein the removable drive assembly includes a plurality of radial vanes to facilitate air flow into the colander.

6. The salad spinner of claim 1, wherein the support frame is a planar rigid surface.

7. The salad spinner of claim 1, wherein the support frame is an open-ended rigid container.

8. The salad spinner of claim 1, wherein the colander is comprised of a collapsible, flexible material.

9. A salad spinner comprising:
a support frame;
a colander supported by the support frame for rotation about an axis of rotation; and
a removable drive assembly removably coupled to the support frame and colander,
wherein the removable drive assembly comprises an actuator and a receiving ring fan mechanically coupled to the actuator and removably coupled the colander, and wherein actuation of the actuator transmits a driving force to rotate the coupled receiving ring fan and colander.

10. The salad spinner of claim 9, wherein the actuator is a manually operated rotating handle.

11. The salad spinner of claim 9, wherein a plurality of radial vanes are located proximate to the receiving ring fan to facilitate air flow into the colander.

12. The salad spinner of claim 9, wherein the support frame is a planar rigid surface.

13. The salad spinner of claim 9, wherein the support frame is an open-ended rigid container.

14. The salad spinner of claim 9, wherein the colander is comprised of a collapsible, flexible material.

15. A salad spinner comprising:
a support frame;
a colander supported by the support frame for rotation about an axis of rotation; and
a removable drive assembly removably coupled to the support frame and colander;
wherein the removable drive assembly comprises a manually operated rotating actuator, a receiving ring fan mechanically coupled to the actuator and removably coupled the colander, and a plurality of radial vanes located proximate to the receiving ring fan wherein actuation of the actuator transmits a driving force to rotate the coupled receiving ring fan and colander.

16. The salad spinner of claim 15, wherein the support frame is a planar rigid surface.

17. The salad spinner of claim 15, wherein the support frame is an open-ended rigid container.

18. The salad spinner of claim 15, wherein the colander is comprised of a collapsible, flexible material.
